(19) United States
(12) Patent Application Publication
(10) Pub. No.: US 2026/0237237 A1
(43) Pub. Date: Aug. 13, 2026

(54) TRANSCRIBING PHOTOGRAPHIC IMAGES

(71) Applicant: DoorDash, Inc., San Francisco, CA (US)

(72) Inventors: Zhe Mai, Kirkland, WA (US); Ying Yang, Cupertino, CA (US); Zheng Hu, Jersey City, NJ (US)

(21) Appl. No.: 19/540,329

(22) Filed: Feb. 13, 2026

Related U.S. Application Data
(60) Provisional application No. 63/758,189, filed on Feb. 13, 2025.

(51) Int. Cl. G06V 30/414; G06V 10/82

(52) U.S. Cl. CPC G06V 30/414; G06V 10/82

(57) ABSTRACT

A method can include obtaining an image of structured text. Transcription text can be generated based on the image using a transcription model. A set of features can be determined based on the image. A first feature subset can be extracted from the image. A second feature subset can be extracted from the transcription text. A first image model, including a first image convolutional network or a first transformer model, can generate an image representation vector using the first feature subset. A tabular layer model can generate a transcription representation vector using the second feature subset. A combination vector can be generated by combining the image and transcription representation vectors. A machine learning classification model can determine an accuracy classification for the transcription text using the combination vector. Responsive to the accuracy classification indicating that the transcription text is accurate, the transcription text can be displayed within an application.

### CROSS-REFERENCES TO RELATED APPLICATIONS

This application claims the benefit of U.S. Provisional Application No. 63/758,189, filed Feb. 13, 2025, which is herein incorporated by reference in its entirety for all purposes.

### SUMMARY

Embodiments are related to methods and systems for efficiently transcribing text from images. Embodiments provide for robust and scalable automation of image transcription by evaluating transcription model output with a machine learning based guardrail model. The transcription model can generate transcription text from an image. The guardrail model can evaluate the quality of transcription text that is generated by a large language model. In some embodiments, the guardrail model can evaluate a plurality of transcription texts that are created by different transcription models (e.g., large language models, multimodal language models, optical character recognition modules, etc.). Embodiments can maintain text quality when provided diverse image formats and variable input quality, making the system practical and adaptable.

One embodiment can be related to a method. A method can include obtaining an image of structured text. Transcription text can be generated based on the image using a transcription model. A set of features can be determined based on the image. A first feature subset of the set of features can be extracted from the image. A second feature subset of the set of features can be extracted from the transcription text. A first image model can generate an image representation vector using the first feature subset. The first image model includes a first image convolutional network or a first transformer model. A tabular layer model can generate a transcription representation vector using the second feature subset. A combination vector can be generated by combining the image representation vector and the transcription representation vector. A machine learning classification model can determine an accuracy classification for the transcription text using the combination vector. Responsive to the accuracy classification indicating that the transcription text is accurate, the transcription text can be displayed within an application.

In some embodiments, generating the transcription text can include the following steps. Raw text can be from the image using an optical character recognition process. A prompt comprising the raw text can be generated using a prompt template. The transcription text can be generated based on the prompt using a language model.

In some embodiments, the transcription text can be first transcription text, the set of features can be a first set of features, the combination vector can be a first combination vector, and the accuracy classification can be a first accuracy classification. The method can include generating a second transcription text based on the image. For example, the second transcription text can be generated by a different large language model than the first transcription text, by an optical character recognition process, or by other image processing methods. A second set of features can be determined based on the image. A second combination vector can be generated from the second set of features. A second accuracy classification for the second transcription text can be determined using the second combination vector. The first accuracy classification and the second accuracy classification can be evaluated to determine a selected transcription text of the first transcription text and the second transcription text.

Another embodiment can be related to a computer comprising a processor and a non-transitory computer readable medium comprising code, executable by the processor for performing the aforementioned method.

Another embodiment can be related to a system an image database and a computer. The image database stores a plurality of images. The computer comprises a processor and a non-transitory computer readable medium comprising code, executable by the processor for performing the aforementioned method.

Further details regarding embodiments of the disclosure can be found in the Detailed Description and the Figures.

### BRIEF DESCRIPTION OF THE DRAWINGS

FIG. 1 illustrates an example transcription of an image of a menu according to embodiments.

FIG. 2 illustrates images that lead to bad transcriptions according to embodiments.

FIG. 3 illustrates example features/inputs for the guardrail machine learning model according to embodiments.

FIG. 4 shows a flow diagram illustrating a first image transcription and evaluation method according to embodiments.

FIG. 5 shows a block diagram illustrating a guardrail model according to embodiments.

FIG. 6 shows a flow diagram illustrating a second image transcription and evaluation method according to embodiments.

FIG. 7 shows a flow diagram illustrating a transcription generation and deployment method according to embodiments.

FIG. 8 shows a block diagram illustrating a delivery system according to embodiments.

FIG. 9 shows a flow diagram illustrating a preparation and delivery method of an item according to embodiments.

FIG. 10 shows a block diagram illustrating a central server computer according to embodiments.

FIG. 11 shows a block diagram illustrating a computer system according to embodiments.

### TERMS

Prior to discussing embodiments of the disclosure, some terms can be described in further detail.

An “item” can be an individual article or unit. Examples of items can include perishable items such as food items, beauty items (e.g., cosmetics), office supply products (e.g., staples, paper, and ink), hardware items (e.g., nails, hammers, wrenches), electronic devices (e.g., computers, phones, etc.), jewelry, etc.

A “user” may include an individual or a computational device. In some embodiments, a user may be associated with one or more personal accounts and/or mobile devices. In some embodiments, the user may be a consumer or a customer.

A “user device” may be a device that is operated by a user. In some embodiments, the user device can be an electronic device that can process information and communicate with other electronic devices. A user device may include a processor and a computer-readable medium coupled to the processor, the computer-readable medium comprising code, executable by the processor. Examples of user devices may include a mobile device, a laptop or desktop computer, a wearable device, etc.

A “transporter” can be an entity that transports something. A transporter can be a person that transports an item using a transportation device (e.g., a car). In other embodiments, a transporter can be a transportation device that may or may not be operated by a human. Examples of transportation devices include cars, boats, scooters, bicycles, drones, airplanes, etc. In some embodiments, the transporter user device can be integrated into a transportation device.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a completed state, or a final state. A fulfillment request can include one or more selected items that a user wishes to obtain from a selected service provider.

A “delivery order” can include a request to deliver one or more items. Delivery orders can include requests to provide one or more items from a pickup location to a drop-off location. Delivery orders can include orders to deliver items from service provider locations to end user locations. Delivery orders can include orders to deliver items from end user locations to service provider locations. An example of this type of delivery order can be a return order (e.g., to deliver an item that is to be returned). A delivery order can include data to fulfill the delivery request including an order type, an indication of an item, a pickup location, and a drop-off location. In some embodiments, the delivery order can include a scheduling range by which the order is to be fulfilled. A delivery order can also include metadata. The metadata can include data relating to the delivery order (e.g., related order numbers, instruction data, etc.).

A “route” can include a way or course taken in getting from a starting point to a destination. For example, a route can indicate a path that can be followed to move from a pickup location to a drop-off location. In some embodiments, a route can indicate a suggested path that a transporter can follow to deliver an item from a service provider to an end user (or vice-versa) for a delivery order. In some embodiments, a route can be referred to as a journey.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, one million, ten million, 100 million, or one billion parameters. An ML model can be generated using sample data (e.g., training samples) to make predictions on test data. Various number of training samples can be used, e.g., at least 10, 100, 1,000, 5,000, 10,000, 50,000, 100,000, or 200,000 training samples. One example is reinforcement learning such as Q-Learning, Deep Q-Networks (DQN), Double DQN, Dueling DQN, Policy Gradient Methods, Actor-Critic, Advantage Actor-Critic (A2C), Proximal Policy Optimization (PPO), Trust Region Policy Optimization (TRPO), and Soft Actor-Critic (SAC). Another example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), multi-class SVM, support vector regression (SVR), Bayesian statistics, case-based reasoning, decision tree learning (e.g., CART (classification and regression trees), gradient boosted trees, or random forest), inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques. Some workflows may also include steps for data pre-processing or handling imbalanced datasets.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “language model” can include a probabilistic model relating to evaluating natural language. A language model can include a large language model (LLM). A large language model can include a transformer and can be utilized to evaluate data other than natural language.

A “training set of training samples” can include a set of data used for training. A training set of training samples can include a plurality of training samples.

A “training sample” can include data used to train a model. A training sample can include a vector, or other data structure. A training sample can include access request data.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

### DETAILED DESCRIPTION

Embodiments provide for technical solutions to a technical challenge of automating the transcription of images that include structured data (e.g., menu photos, documents, etc.). Various embodiments can use generative AI models (e.g., large language models (LLMs)), which can be used in combination with other machine learning (ML) techniques. While large language models offer significant potential to automate and streamline the extraction of structured data from images, their accuracy varies widely due to the diverse nature and quality of the images. Furthermore, large language models suffer from generating incorrect information. Various embodiments can provide for a hybrid pipeline that guardrails the use of large language models, thus providing for improved image transcription accuracy.

Embodiments solve a technical problem of how to improve accuracy of transcription text from images in an automated transcription text deployment pipeline. Embodiments provide for improved accuracy by utilizing multiple modes of data (e.g., image data, transcription data, bounding box data, etc.) when evaluating the accuracy of transcription text determined from an image.

Embodiments provide for transcription models that can generate transcription text based on an image. An example transcription model can include an optical character recognition module paired with a large language model. The optical character recognition module can generate raw text from the image. The large language model can generate transcription text from the raw text. Another example transcription model can include a multimodal language model, which can generate transcription text based on the image.

A guardrail model can then evaluate the transcription text. The guardrail model can include a machine learning classification model. The guardrail model can be trained to generate an accuracy classification that indicates how accurate the transcription text is to the text that is captured in the image.

To evaluate the transcription text, the guardrail model can determine a set of features based on the image. A first feature subset can include data relating to the image itself. For example, the first feature subset can be extracted from the image. The first feature subset can indicate data related to the image, such as pixel level data. A second feature subset can include the transcription text. A third feature can include data related to optical character recognition bounding boxes generated by an optical character recognition module.

The guardrail model can generate a combination vector from the set of features. For example, the guardrail model can combine the features of the set of features into a single combination vector that represents the image and the transcription. After generating the combination vector, the guardrail model can determine an accuracy classification for the transcription text using the combination vector. The accuracy classification can indicate how accurate the transcription text is to the contents of the image.

### I. INTRODUCTION

Large language models are able to learn and utilize language in certain contexts. Embodiments can utilize large language models to automatically transcribe and summarize structured images. However, with a vast variety of structures images might capture, it has been observed that an inherent technical challenge for large language models is to perform a highly accurate task at scale. In order to better take advantage of the advantages that large language models can bring, embodiments can combine traditional machine learning techniques with LLM to build a highly accurate AI system.

Embodiments combine machine learning models with large language models to provide a guardrail on the performance of the large language model. Embodiments provide for a machine learning model that can identify cases where the large language model will be able to provide a more accurate answer.

Embodiments solve a technical problem of the guardrail model needing to learn how the large language model interacts with images for transcription to understand the factors that cause low accuracy and eventually translate the factors to features for the guardrail model. During experiments, images were evaluated in depth to understand these interactions and a set of features was identified that allows a computer to successfully target the correct set of images that the large language model can achieve good accuracy on.

A service provider's (e.g., a restaurant) menu can represent the service provider's offerings to end users on a delivery platform. To ensure accuracy and alignment with the latest in-store offerings, the service provider must actively maintain their menus. However, this can be challenging for service providers that are already managing demanding daily operations.

Updating the service provider menus is traditionally a human-managed process. Embodiments provide for systems and methods to improve the process of updating menus, by streamlining menu updates and enhancing efficiency. Traditionally, the delivery platform (e.g., a central server computer) can receive many images of menus (e.g., photographic images of structured text) from service providers requesting for the menus to be updated on the delivery platform, which is included in a queue for a team of humans to manually update. This is a time consuming process.

Embodiments can utilize large language models to automatically transcribe needed information from the menus. However, with a vast variety of menu structures service providers have, there is an inherent challenge for large language models to do a highly accurate job at scale. Embodiments can solve such problems with using large language models to determine menu transcription from images of menus by combining other machine learning techniques with large language models to build a highly accurate AI system.

As an illustrative example, embodiments provide for a processing system that can include a model that uses optical character recognition (OCR) to extract text information from a menu image, uses a large language model for item-level information extraction and summarization, and creates a structured data format that can be used to update the menu listing on the delivery platform.

### II. TRANSCRIPTION OF IMAGES

Embodiments provide for an automated process by which photographic images of structured text, such as restaurant menus, are converted into structured, machine-readable data using a combination of optical character recognition, large language models, and machine learning techniques. Embodiments address the inherent challenges posed by the wide variability in menu formats, image quality, and content completeness that are prevalent in real-world service provider submissions. By leveraging a hybrid pipeline, the system can first extract raw text from menu images through OCR and then utilizes a language model to organize and summarize this information into standardized data formats. To overcome particular challenges in image data extraction, the embodiments introduce a guardrail model that evaluates the suitability of LLM-based automation on a case-by-case basis, ensuring only high-confidence transcriptions are automated while detecting problematic cases.

### A. Automating Transcription

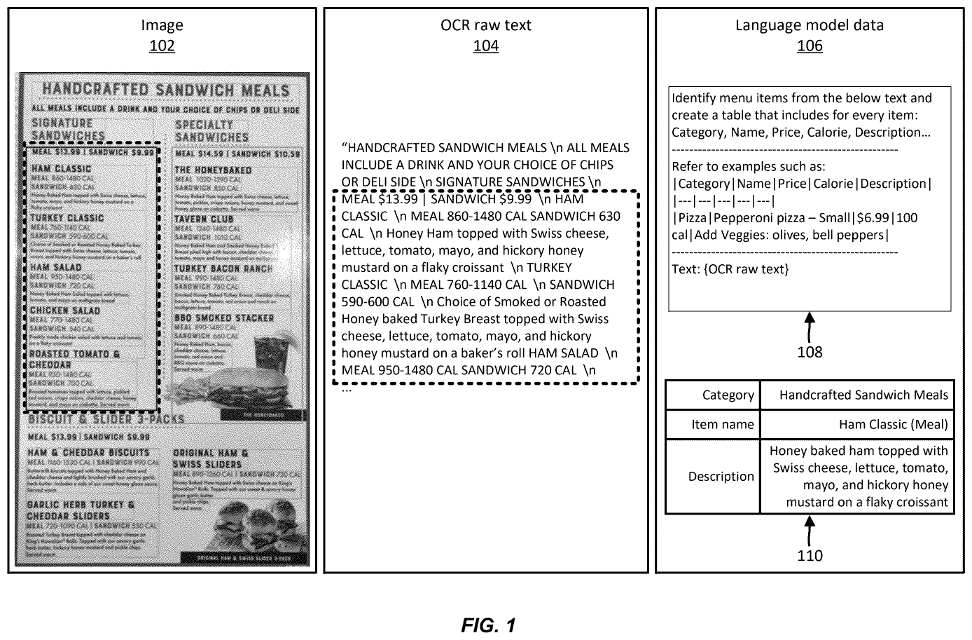

FIG. 1 illustrates an example transcription of an image of a menu according to embodiments. FIG. 1 includes an image 102, an OCR raw text 104, and language model data 106.

The image 102 can be a photographic image of structured text. For example, the image 102 can be a photo of a menu. The image 102 can be provided to a computer, such as a central server computer, from a service provider computer. The image 102 can include an image of text on a menu that indicates information relating to one or more items provided by the service provider associated with the service provider computer.

The OCR raw text 104 can include text determined from an OCR process using the image 102. The OCR raw text 104 can include text that is identified as being in the image 102. For example, the central server computer can generate the OCR raw text 104 by applying an optical character recognition (OCR) algorithm to the image 102. The OCR process may also involve pre-processing steps such as image enhancement, binarization, noise reduction, etc. to improve text detection accuracy.

The resulting OCR raw text 104 can be a textual representation of the contents of the structured text in the image (e.g., a menu's contents, a document's contents, etc.), including item names, descriptions, prices, titles, deals, specials, categories, and/or any other visible alphanumeric characters.

The language model data 106 can include a prompt 108 that is generated based on the OCR raw text 104 and a template. The language model data 106 can also include tabular data 110.

The prompt 108 can be constructed by formatting the OCR raw text 104 into a structured input according to a predefined template designed to elicit itemized menu information from the large language model. The prompt may include instructions for the language model to extract and organize menu items, descriptions, associated prices, etc. into a specific format, such as a JSON or tabular structure. For example, the prompt may explicitly ask the language model to identify each menu item, categorize items, and associate prices with their respective items. The prompt 108 may also incorporate rules, such as how to handle missing text, multi-option items, or category headers, to standardize the language model's output.

The tabular data 110 can be a table of data. The tabular data 110 can be output by the large language model. The tabular data 110 can include a structured representation of the text in the image 102. For example, the tabular data 110 can include a structured, item-level representation of the menu, with each row corresponding to a distinct menu item. Columns of the tabular data 110 may include the item name, description, category, price, any available options or modifiers, etc. The tabular data 110 can allow for direct integration into digital menu systems, automated updating of restaurant listings, and further downstream processing. In some embodiments, the tabular data 110 may also include additional fields generated by the language model, such as ingredient lists, dietary labels, etc. depending on the template used and the information detected in the menu image 102. The tabular data 110 can provide a machine-readable, standardized output that facilitates automation and reduces the need for manual data entry or correction.

Tabular features can be captured from the image and from the OCR raw text. The tabular features (e.g., the transcription text formatted as a table) can include a number of unique menus, a number of categories per menu, a number of items per menu, a number of items with options, a median price, an average price, a matcher rate, a percent of usable items, etc. OCR raw text tabular features can include a number of characters, a number of words, a number of sentences (OCR blocks), a number of dollar signs, a number of digits tokens (1 digit, 2 digits token, 3+ digits), etc.

The features extracted from the image can relate to the OCR raw text. The features can relate to the menu of the service provider and the item structure characteristics. The features can relate to the photo quality.

### B. Failure Cases Impacting Transcription Accuracy

However, using large language models introduce a number of technical problems. Large language models can provide great summarization and organization capability through text understanding. However, large language models have shortcomings when scaling them in production.

Through experimental evaluation on a large number of menu photos, it was discovered that a reasonable proportion of menus were transcribed with various errors, such as incorrect item names, or categories for correct item names. The transcription errors typically occurred within the following 3 types of menu photos: 1) inconsistent menu structure, leading to confusing OCR raw texts, 2) incomplete menus, causing difficulty in the correct linkage between items and their attributes, and 3) non-desirable menu photo quality (e.g., too dark, too many flares, too many irrelevant items in the foreground or background, etc.).

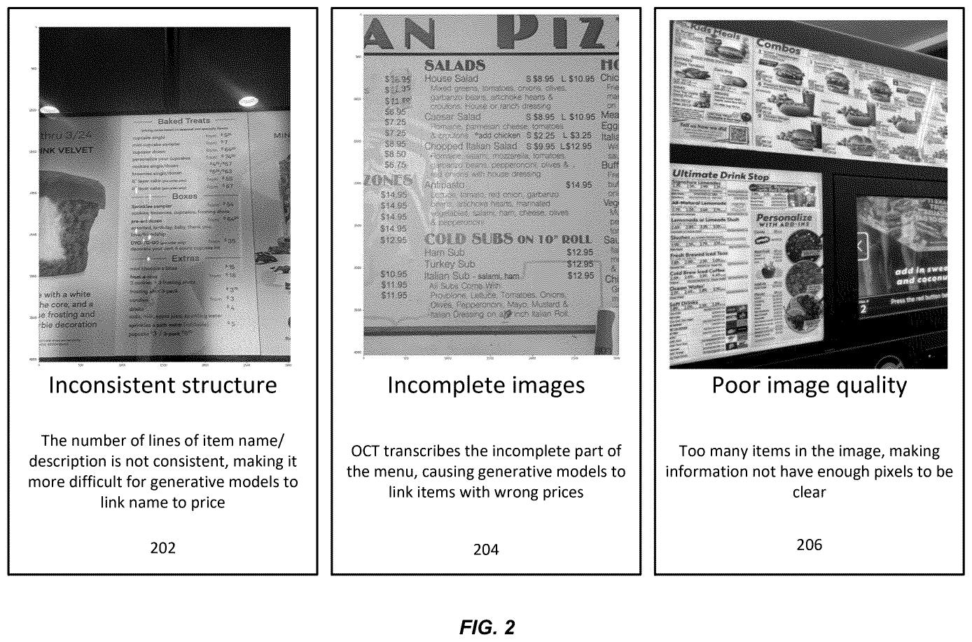

FIG. 2 illustrates images that lead to bad transcriptions according to embodiments. FIG. 2 includes three example images that lead to bad transcriptions. FIG. 2 includes an inconsistent menu structure image 202, an incomplete menu image 204, and a bad quality/too many items image 206.

The inconsistent menu structure image 202 can include a number of lines of item names and/or descriptions that isn't consistent throughout the image. The inconsistency of the menu's structure makes it difficult to capture links between item names and item prices.

The incomplete menu image 204 can include sections of text that are not fully shown in the image. An OCR process can transcribe the incomplete sections of text in the image, which causes incorrect linking between item names and item prices.

The bad quality/too many items image 206 can include an image that is too blurry to determine text in the image, includes text that is too small compared to the image resolution, and/or includes additional items in the image that are not the menu.

The fundamental reason for the low accuracy is inevitably the performance gap of large language models. However, no matter how much improvement to accuracy for a single LLM is made, a single LLM flow often still does not meet high accuracy product requirements. To solve such a technical problem, embodiments utilize an automatic guardrail process.

Embodiments provide for a guardrail machine learning model that evaluates outputs from the large language model. One goal of the guardrail machine learning model is to identify whether a LLM transcription can meet a high accuracy goal, which plays a key role to ensure accountability at scale when going to production. Furthermore, with the rapid development of generative AI models, the guardrail model framework also needs to be flexible for any quick adaptations.

Embodiments provide for generating the right features for guardrail model training. In order to determine and understand the transcription quality, the machine learning model can learn how each menu photo interacts with both parts of the transcription model, that is the OCR and the LLM summarization. The guardrail machine learning model can be provided with the right set of features to properly inform these interactions. Based on the 3 different types of error-prone menu images described in FIG. 2, the guardrail machine learning model can evaluate features relating to reasons for the failing of the transcription.

Images of menus that include an inconsistent menu structure lead to an OCR raw text's lack of logical order. For example, an OCR process can have trouble reading a menu by category or any certain order. In fact, it is observed that the order of text recognition can be arbitrary. This can cause a higher difficulty for the large language model to link the right item attributes together.

Images of menus that include incomplete menus lead to an OCR process outputting the attributes from the items that are only partially visible, resulting in cases where there are more or mismatched attributes, thus introducing noise to the large language model for the correct item< >attribute linkage.

Images of menus that have bad image quality also leads to failures in the transcription process. The OCR process can be great at recognizing all texts, but when the menu fonts are too small in the photo to be visible even by human eyes, or when too many objects in the foreground and/or background are detected, the OCR process can have lowered accuracy for outputting the correct texts.

### C. Bounding Boxes

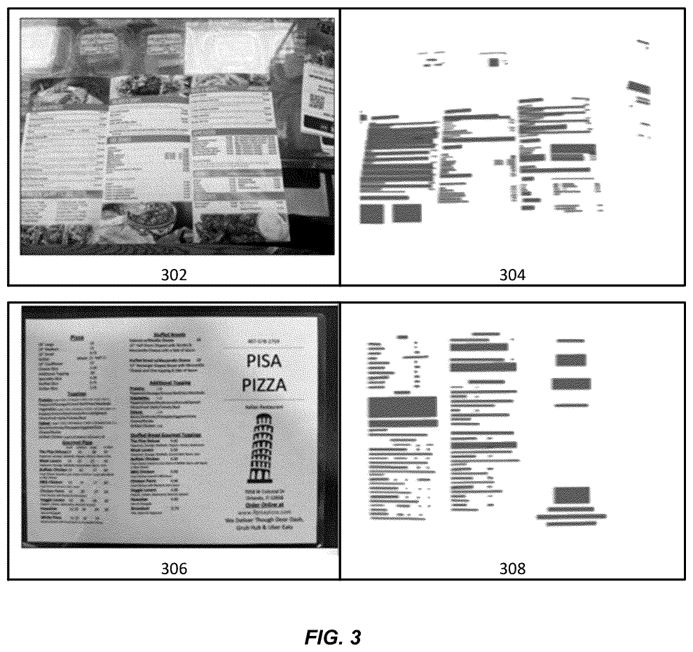

Due to such failings in the transcription process, embodiments can introduce additional data into the guardrail machine learning model for transcription evaluation. The guardrail machine learning model can obtain, for example, three types of features/inputs. FIG. 3 illustrates example features/inputs for the guardrail machine learning model according to embodiments.

FIG. 3 includes a first photographic image 302, a first bounding box image 304, a second photographic image 306, and a second bounding box image 308. The first photographic image 302 includes an image of a menu. The first bounding box image 304 includes bounding boxes of the text in the first photographic image 302 as determined through an OCR process. The second photographic image 306 includes an image of a menu. The second bounding box image 308 includes bounding boxes of the text in the second photographic image 306 as determined through an OCR process.

For a photographic image of a menu, the captured features can include an overall menu position and a photo quality (e.g., blurry, shadow, flare, etc.).

For the bounding box images, the captured features can include information regarding how the OCR process reads the menu image and the position and density of the OCR bounding boxes relative to the photo size (e.g., which can indicate information such as if the menu is behind the counter or is a large menu).

The OCR process can generate the first bounding box image 304 and the second bounding box image 308. As an illustrative example, an optical character recognition module can detect and segment individual text lines, words, and/or characters an image. The optical character recognition module can generate bounding boxes that define the precise spatial coordinates of each recognized text segment within the image. The optical character recognition module can generate the bounding boxes by analyzing the image to identify contiguous regions of pixels that share properties consistent with textual content, such as contrast, edge density, or alignment. The optical character recognition module may utilize connected component analysis, projection profiles, or deep learning-based object detection algorithms to localize each text element. For each detected region, the optical character recognition module can calculate the minimum enclosing rectangle or quadrilateral that contains all the pixels associated with the text segment. The bounding box can be defined by the pixel coordinates of its corners, typically as (x_min, y_min, x_max, y_max), corresponding to the upper-left and lower-right corners of the box.

For example, the optical character recognition process can include determining segments of text in the image (e.g., using computer vision techniques and/or machine learning). For each segment of text in the image, pixel coordinates of a quadrilateral that encompasses the segment can be determined. The optical character recognition process can then generate the optical character recognition bounding box image using the pixel coordinates of each quadrilateral.

Each bounding box can be associated with a specific segment of recognized text. For example, a bounding box can be defined by the pixel coordinates of two or more corners. A bounding box image, such as the first bounding box image 304, can be generated by creating an image where pixels are colored based on whether or not they are included within a bounding box. As such, the bounding box image can visually indicate which pixels are included within the bounding box(es) that were determined during the optical character recognition process.

As an illustrative example, a computer system performing the optical character recognition process can first perform pre-processing of the image. For example, the computer system can apply image enhancement techniques such as de-noising, contrast adjustment, binarization, or deskewing to improve text visibility and alignment.

The computer system can then initiate text region detection. The computer system can analyze the pre-processed image to identify regions likely to contain text. For example, the computer system can utilize techniques such as edge detection, connected component analysis, or deep learning-based text detection to localize text areas.

After identifying regions likely to contain text, the computer system can perform text segmentation. The computer system can segment the detected text regions into finer elements, such as text blocks, lines, words, or individual characters. For example, for each segment, the computer system can calculate a spatial coordinate that define the segment's location in the image.

The computer system can then generate bounding boxes. The bounding boxes can encompass the segments of detected text. For each segmented text element (e.g., line, word, or character), the computer system can generate a bounding box. The bounding box can be represented by the pixel coordinates of the upper-left and lower-right corners or as a quadrilateral. The computer system can also generate a mask or bounding box image that depicts where the bounding boxers are visually in the image. The computer system can generate a bounding box image that includes all of the generated bounding boxes.

After generating the bounding boxes and the bounding box image, the computer system can perform character recognition. Within each bounding box, the computer system can apply pattern recognition (e.g., pattern matching) or deep learning algorithms to convert the visual representation of text into machine-readable alphanumeric characters. The computer system can generate raw text from the image. In some embodiments, the computer system can assign a confidence score to the recognized text in each bounding box.

Further details related to an optical character recognition process can be found in “Haoran Wei et al. General OCR Theory: Towards OCR-2.0 via a Unified End-to-end Model, arXiv, 2024, arXiv: 2409.01704,” which is incorporated herein for all purposes.

### III. TRANSCRIPTION GENERATION

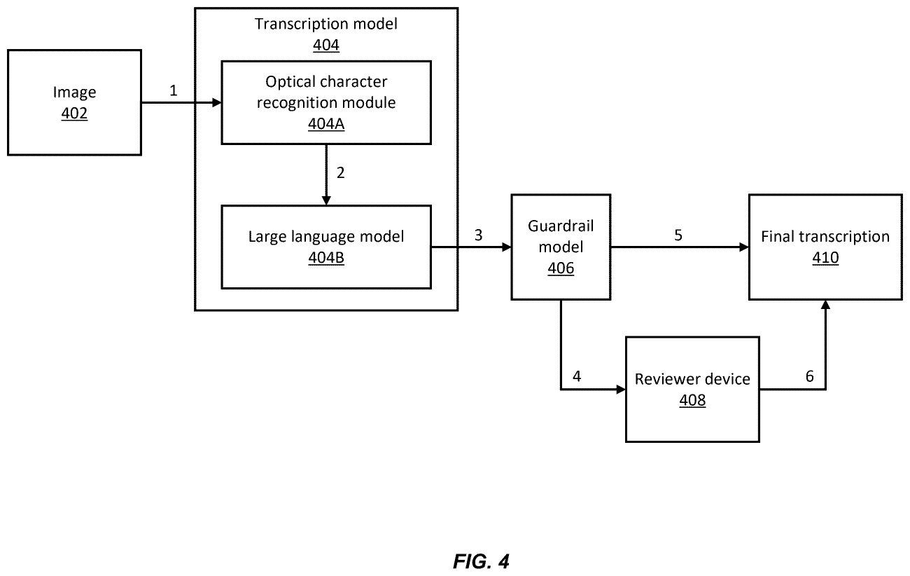

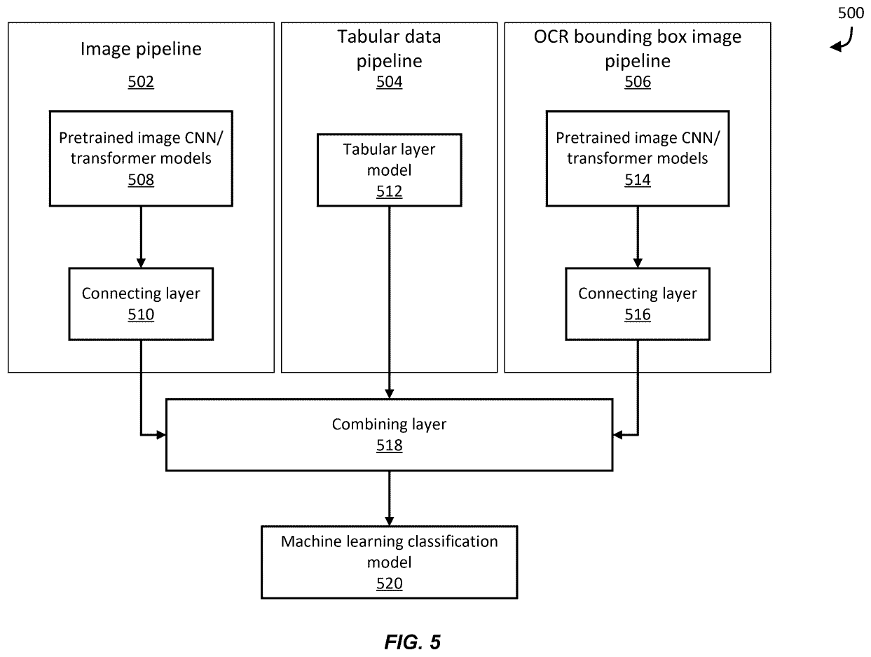

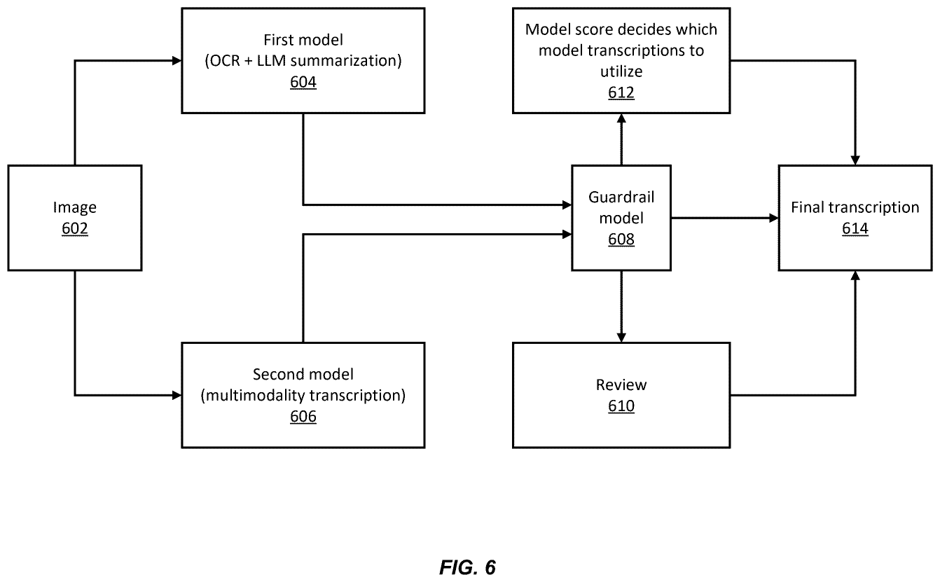

Embodiments provide for systems and methods for converting photographic images of structured text, such as restaurant menus, into machine-readable structured data. This section describes the core workflow for transcription automation, beginning with the extraction and engineering of features from the photographic image, and proceeding through the use of machine learning models to evaluate and generate accurate transcriptions. FIG. 4 describes a OCR-LLM transcription pipeline with guardrail-guided automation, demonstrating the integration of optical character recognition, large language models, and a guardrail model. FIG. 5 presents the neural network architecture for the guardrail model. FIG. 6 describes a multimodal transcription pipeline with guardrail-based model selection, enabling the simultaneous evaluation of outputs from multiple generative AI and large language models, and automatically selecting the highest-quality transcription for downstream use.

A. OCR-LLM Transcription Pipeline with Guardrail

Embodiments provide for an image transcription and evaluation method. The image transcription and evaluation method can include generating transcription text from an image and evaluating the transcription text using a guardrail model to determine an accuracy classification. The accuracy classification can indicate how accurately the transcription text matches the content of the image.

FIG. 4 shows a flow diagram illustrating a first image transcription and evaluation method according to embodiments. FIG. 4 illustrates an automatic image transcription pipeline with a guardrail model. The method illustrated in FIG. 4 can be performed by a computer system such as a central server computer.

Prior to step 1, the computer system can obtain an image 402. The computer system can obtain the image 402 from a database 400 or from another computer. For example, the image 402 can be an image of a menu provided by a service provider. The computer system can obtain the image 402 from a service provider computer of the service provider, or can be obtained from an image database that stores images obtained from service provider computers.

At step 1, after obtaining the image 402, the computer system can utilize a transcription model 404 to generate raw text. The transcription model 404 can include an optical character recognition module 404A and a large language model 404B. However, it is understood that the transcription model 404 can include other components, such as a multimodal language model.

The computer system can input the image 402 into the transcription model 404, which can first process the image using the optical character recognition process, to obtain the raw text from the image. In particular, the computer system can input the image 402 into the optical character recognition module 404A.

The optical character recognition module 404A can perform an optical character recognition process. The optical character recognition process can include pre-processing the image by applying one or more enhancement techniques such as brightness and contrast adjustment, de-noising, and binarization to improve text visibility and segmentation. The optical character recognition module 404A can then detect and segment text regions within the image, generate bounding boxes around detected text (e.g., as described above), and apply character recognition algorithms to convert the visual text into machine-readable alphanumeric characters. The optical character recognition process may also assign confidence scores to recognized text segments and output structured metadata, such as the spatial position of each detected word or line within the image.

The optical character recognition module 404A can utilize matrix matching, feature extraction, or other suitable technique to create a ranked list of candidate characters.

Matrix matching can involve comparing an image to a stored glyph on a pixel-by-pixel basis. Matrix matching may rely on the input glyph being correctly isolated from the rest of the image, and the stored glyph being in a similar font and at the same scale. This technique works best with typewritten text, but may not work well when new fonts are encountered.

Feature extraction decomposes glyphs into features such as lines, closed loops, line directions, and line intersections. Extracting features can reduce the dimensionality of the representation and can make the recognition process computationally efficient. These features can be compared with an abstract vector-like representation of a character, which might reduce to one or more glyph prototypes. Nearest neighbor classifiers (e.g., k-nearest neighbors algorithm, etc.) can be utilized to compare image features with stored glyph features and choose the nearest match.

As an illustrative example, in some embodiments, the optical character recognition module 404A can include processing based on Tesseract, CuneiForm, Minstral OCR, Google Docs OCR, ABBYY FineReader, Transym, OCRopus, etc. Software such as Cuneiform and Tesseract use a two-pass approach to character recognition. The second pass is known as adaptive recognition which uses the letter shapes recognized with high confidence on the first pass to better recognize the remaining letters on the second pass. This is advantageous for unusual fonts or low-quality scans where the font is distorted (e.g. blurred or faded).

In some embodiments, the optical character recognition module 404A can target typewritten text, one glyph or character at a time. In other embodiments, the optical character recognition module 404A can target typewritten text, one word at a time. In other embodiments, the optical character recognition module 404A can target handwritten printscript or cursive text one glyph or character at a time (e.g., intelligent character recognition (ICR)). In yet other embodiments, the optical character recognition module 404A can target handwritten printscript or cursive text, one word at a time (e.g., intelligent word recognition (IWR)).

In some embodiments, the optical character recognition process can output the bounding boxes as an image (e.g. a mask image) along with the raw text.

At step 2, after obtaining the raw text, the computer system can determine transcription text based on the text using the large language model 404B. The large language model 404B can include an artificial intelligence system that can be designed to understand, generate, and manipulate language using deep learning architectures (e.g., based on transformer networks). The large language model 404B can be trained on a large corpora of text data, enabling the large language model 404B to capture complex linguistic patterns, contextual relationships, and nuanced semantics. The large language model 404B can be capable of performing a wide range of natural language processing tasks, including text summarization, translation, question answering, information extraction, and content generation. Example implementations of a large language model include OpenAI's GPT series (e.g., GPT-3 and GPT-4), PaLM, and LLaMA.

The computer system can generate a prompt using the raw text that was generated by the optical character recognition module 404A. The prompt can be generated using a prompt template. For example, the prompt template can include predefined instructions for the large language model 404B to extract specific information from the raw OCR output, such as identifying menu item names, associating prices with each item, categorizing items under appropriate headings, recognizing special attributes like options, etc.

The prompt can include rules and other text that can help guide the large language model 404B. For example, the prompt may specify instructions such as “ignore extraneous or decorative text,” “group items under the nearest identified category heading,” or “if a price is missing, leave the price field blank.” Additional rules may instruct the large language model 404B to standardize currency symbols, resolve OCR errors (e.g., misreading ‘$’ as ‘S’), or prioritize clearer text blocks over ambiguous ones. The rules within the prompt can aid the large language model 404B in interpreting the raw text in a consistent and application-specific manner.

The prompt can be input into the large language model 404B to determine the transcription text. For example, the computer system can input the prompt, which can include the raw text, as illustrated in Table 1, below, into the large language model 404B.

TABLE 1
Example large language model input

Identify menu items from the below text and create a table that includes
for every item: Category, Name, Price, Calorie, Description...
------------------------------------------
Refer to examples such as:
| Category | Name | Price | Calorie | Description |
| --- | --- | --- | --- | --- |
| Pizza | Pepperoni pizza -Small | $6.99 | 100 cal | Add Veggies: olives,
bell peppers |
------------------------------------------
Text: {OCR raw text}

The large language model 404B can process the input provided by the computer system. The large language model 404B can generate an output based on the input. The output can include transcription text, which can be formatted as tabular data. The computer system can obtain the transcription text from the large language model 404B. For example, the computer system can obtain the transcription text illustrated in Table 2, below, which shows a portion of the transcription text as tabular data for a single item.

TABLE 2
Example large language model output

| Category | Item name | Description |
|---|---|---|
| Handcrafted | Ham | Honey Baked Ham topped with Swiss |
| Sandwich | Classic | cheese, lettuce, tomato, mayo, and |
| Meals | (Meal) | hickory honey mustard on a flaky croissant |

The tabular data can be a structured, machine-readable representation of the menu or other structured text found in the image. For example, the tabular data may include columns corresponding to item names, item descriptions, item categories, prices, optional modifiers, etc. Each row in the table can represent a distinct menu item, allowing for direct integration into digital databases, online listings, or other applications. In some embodiments, the tabular data may also include additional fields such as dietary information, allergen warnings, or promotional tags, depending on the context and the information present in the original image.

At step 3, after determining the transcription text, the computer system can determine whether or not the transcription text is accurate. The computer system can determine whether or not the transcription text is accurate using a guardrail model 406.

The guardrail model 406 can include a neural network. The guardrail model 406 can accept at least the transcription text as input. The guardrail model 406 can also accept other data as input along with the transcription text. For example, the guardrail model 406 can also accept the image and an image of OCR bounding boxes. The guardrail model 406 can be trained to determine an accuracy classification based on the input. The accuracy classification can be an accuracy value (e.g., 0-1) or an accuracy category (e.g., accurate or not accurate). Further details of the guardrail model are described in reference to FIG. 5, below.

The computer system can determine the accuracy classification using the guardrail model. If the accuracy classification indicates that the transcription text is accurate, then the computer system can proceed to step 410. If the accuracy classification indicates that the transcription text is not accurate, then the computer system can proceed to step 408.

At step 4, if the guardrail model 406 determines that the transcription text is not accurate, then the computer system can add the transcription text and/or the image into a review queue for human transcription. The transcription text can be flagged as not accurate. A reviewer can review the transcription text and/or the image and can create an accurate transcription text and provide the accurate transcription text to the computer system.

For example, a reviewer device 408 can obtain the transcription text from the guardrail model 406, or from a review database. The reviewer device 408 can obtain the transcription text in, for example, a review message. The reviewer device 408 can receive user input from a user (e.g., a reviewer). The user input can include an accurate transcription text that is created by the user. The reviewer device 408 can generate a completed review message comprising the accurate transcription text based on the user input. The review device 408 can provide the completed review message to the computer system.

As an illustrative example, the computer system can generate a review message comprising the transcription text, the image, the raw text, the OCR bounding boxes, and/or other related data. The computer system can provide the review message to a review database. A reviewer device operated by a reviewer can access the review database to obtain the review message. The reviewer can evaluate the contents of the review message and generate an accurate transcription text. The reviewer device can generate a completed review message comprising the accurate transcription text and can provide the completed review message to the computer system. Upon receiving the completed review message, the computer system can proceed to step 410.

At steps 5 and 6, after obtaining transcription text that is accurate, the computer system can include the transcription text into a listing, profile, or other data structure related to the service provider associated with the image. For example, the computer system can update the service provider's menu listing on an online delivery platform by integrating the accurate transcription text into the service provider's digital profile. This may involve mapping each transcribed menu item, price, and category into the platform's structured database, providing updates for end users browsing the service provider's offerings.

As such, embodiments provide for a hybrid automation transcription pipeline. In this pipeline, all received and validated images can be provided to the transcription model, which includes an OCR process and a large language model, whose features and performance will be generated and evaluated by the guardrail model. For the images that pass an accuracy evaluation threshold, their transcribed information will be readily available to be utilized, otherwise, the system will provide the images to the human evaluation process.

### B. Guardrail Model

The computer system can obtain a set of features related to the image and the contents of the image. For example, the set of features can include the image itself, tabular data, and OCR bounding box images. The set of features can be processed by a guardrail model to evaluate accuracy of the transcription.

FIG. 5 shows a block diagram illustrating a guardrail model according to embodiments. FIG. 5 includes a guardrail model 500 that can accept one or more inputs depending on the overall structure of the system and which features are available for use in the guardrail model 500. The guardrail model 500 can accept data in an image pipeline 502, in a tabular data pipeline 504, and/or in an OCR bounding box image pipeline 506.

The process illustrated in reference to FIG. 5 can be performed by a computer system, such as a central server computer. The computer system can provide data from a transcription model (e.g., such as at step 404 of FIG. 4.) into the guardrail model 500. The computer system can provide images to the guardrail model 500 via the image pipeline 502. The computer system can provide tabular data to the guardrail model 500 via the tabular data pipeline 504. The computer system can provide OCR bounding box images to the guardrail model 500 via the OCR bounding box image pipeline 506. The guardrail model 500 can determine a set of features using the image pipeline 502, the tabular data pipeline 504, and the OCR bounding box image pipeline 506.

### 1. Image Pipeline

The image pipeline 502 within the guardrail model 500 can extract visual features from images to aid in the transcription accuracy determination process. The image pipeline 502 can utilize a pretrained image convolutional neural network or a transformer model to generate features related to the image. These features can capture attributes related to the image's quality (e.g., sharpness, contrast, the presence of glare or shadows, etc.) and the overall layout and structure of the content depicted in the image. The features identified by the image pipeline 502 can aid the guardrail model 500 in determining whether the image is suitable for accurate automated transcription or if it may present challenges, such as poor quality, clutter, or atypical arrangements, that could lead to errors. To facilitate integration with other pipelines (e.g., other data modalities), the high-dimensional output from the image model can be further processed by a connecting layer (e.g., a projection or flattening layer) that can transform the data into a fixed-size combination vector.

The image pipeline 502 of the guardrail model 500 can process the image (e.g., the image of the menu) using a pretrained image convolutional neural network (CNN) or a transformer model 508. The pretrained image CNN (e.g., VGG16, ResNet, etc.) or the transformer model (e.g., vision transformer (ViT) or DiT) can extract high-level visual features from the photographic image. These features may capture characteristics related to image quality (e.g., sharpness, contrast, presence of glare or shadows), layout patterns, and the overall structure of the menu within the image. The extracted visual features aid in providing signals for the guardrail model 500 to assess whether the image content is suitable for automated transcription and to identify visual factors that might lead to transcription errors.

The pretrained image CNN or the transformer model 508 can output a vector that encodes learned representations of the image's visual content. The vector can represent the image.

The guardrail model 500 can process the vector output of the pretrained image CNN or the transformer model 508 in a connecting layer 510, which is optional. The connecting layer 510 can be a projection layer. The connecting layer 510 can transform the input vector into a different dimensionality. For example, the connecting layer 510 can transform the input vector from a high dimensionality to a fixed lower dimensionality. The connecting layer 510 can be trained to optimally transform the input vector into a different dimensionality, such as a lower dimensionality. The lower dimensionality output vector can be an image representation vector that represents the image.

In some embodiments, the connecting layer 510 can apply an operation on the input vector, such as matrix multiplication. The connecting layer 510 can be trained to optimize weights in a weight matrix, which are learned over training iterations. The connecting layer 510 can project the input vector into the lower dimensionality output vector using the weight matrix.

The image pipeline 502 can output an image representation vector. By transforming the input vector's dimensionality, the guardrail model 500 can more seamlessly concatenate or otherwise combine the image representation vector with vectors from the other pipelines (e.g., other modalities).

### 2. Tabular Data Pipeline

The tabular data pipeline 504 within the guardrail model 500 can extract transcription text features from transcription text, which was generated based on the image processed by the image pipeline 502, to aid in the transcription accuracy determination process. The tabular data pipeline 504 can process structured, non-image features derived from the input image and its associated transcription outputs. To evaluate features related to the transcription text as formatted as tabular data, the tabular data pipeline 504 can utilize a tabular layer model 512. The tabular layer model 512 can output a transcription representation vector that represents the transcription text.

The guardrail model 500 can evaluate the tabular data pipeline 504 using the tabular layer model 512. The tabular layer model 512 can be a neural network. In some embodiments, the tabular layer model 512 can include fully connected layer(s). A fully connected layer can include a neural network in which each neuron applies a linear transformation to the input vector through a weights matrix. As a result, all possible connections layer-to-layer are present. Each input of the input vector influences every output of the output vector.

### 3. OCR Bounding Box Image Pipeline

The OCR bounding box image pipeline 506 within the guardrail model 500 can extract OCR bounding box image features from an OCR bounding box image, which was generated during image OCR based transcription, to aid in the transcription accuracy determination process. The OCR bounding box image can encode spatial information by delineating the precise areas where textual content is present, as well as revealing the overall distribution and organization of text elements across the image. By processing the OCR bounding box image with a pretrained image convolutional neural network or a transformer model, the OCR bounding box image pipeline 506 can extract high-level spatial and density features that capture aspects of the text layout, such as the arrangement, clustering, or dispersion of text blocks, and the presence of occlusions, overlaps, or out-of-place text.

For the OCR bounding box image pipeline 506, the guardrail model 500 can process an OCR bounding box image that corresponds to the photographic image in a pretrained image CNN or a transformer model 514. The OCR bounding box image can represent a visual overlay highlighting regions of detected text within the original image, as identified by the OCR process (e.g., as illustrated in the second bounding box image 308 of FIG. 3). By processing this OCR bounding box image through a the pretrained image CNN or the transformer 514, the OCR bounding box image pipeline 506 can extract spatial and density features that describe how text is distributed through the image, the complexity of layout, and potential occlusions or overlaps. These features can aid the guardrail model 500 in recognizing challenging scenarios such as cluttered menus, menus with text outside expected regions, or menus with dense or sparse text arrangements that may impact transcription reliability.

In some embodiments, the pretrained image CNN or transformer model 508 utilized in the image pipeline 502 can be similar to the pretrained image CNN or transformer model 514 utilized in the OCR bounding box image pipeline 506.

The pretrained image CNN or the transformer model 514 can output a vector that encodes learned representations of the OCR bounding box image's visual content. The vector can represent locations in the image that contain text that was utilized to determine the transcription text.

The guardrail model 500 can process the output of the pretrained image CNN or the transformer model 514 with a connecting layer 516. The connecting layer 516 can convert the OCR bounding box image features into a fixed-size vector, which can be aligned with the features of the other pipelines.

For example, the guardrail model 500 can process the vector output of the pretrained image CNN or the transformer model 514 in the connecting layer 516. The connecting layer 516 can be a projection layer. The connecting layer 516 can transform the input vector into a different dimensionality. The connecting layer 516 can be trained to optimally transform the input vector into a lower dimensionality. The lower dimensionality output vector can be an OCR bounding box image representation vector that represents the OCR bounding box image.

In some embodiments, the connecting layer 516 can apply an operation on the input vector, such as matrix multiplication. The connecting layer 516 can be trained to optimize weights in a weight matrix, which are learned over training iterations. The connecting layer 516 can project the input vector into the lower dimensionality output vector using the weight matrix.

The OCR bounding box image pipeline 506 can output an OCR bounding box image representation vector. By transforming the vector's dimensionality, the guardrail model 500 can more seamlessly concatenate or otherwise combine the OCR bounding box image representation vector with vectors from the other pipelines.

### 4. Combining Pipeline Features

After determining the set of features comprising features from each pipeline, the guardrail model 500 can utilize a combining layer 518 to combine each feature of the set of features into a single combination vector. The combination vector can represent the image, the transcription text, and the OCR bounding box image. The computer system can generate the combination vector based on each feature of the set of features using the combining layer 518, which can include a fully connected neural network that is trained to combine inputs into a single output.

The guardrail model 500 can use the combining layer 518 to combine feature data determined from each pipeline. In some embodiments, the combining layer 518 can include a fully connected layer to combine and evaluate data from the image pipeline 502, the tabular data pipeline 504, and the OCR bounding box image pipeline 506.

The combining layer 518 can act as a feature fusion stage, aggregating the distinct but complementary information derived from the image, the OCR bounding box image, and the tabular data into a unified feature representation. Through a series of, for example, learned linear transformations and nonlinear activations, the combining layer 518 may allow the guardrail model to capture complex interactions between visual, spatial, and textual features. This joint representation can allow the guardrail model 500 to assess nuanced indicators of transcription quality, leading to a more accurate and robust prediction of whether the image is suitable for automated transcription. For example, the indicators of transcription quality may include the relationship between layout density and OCR token counts, how image quality metrics interact with menu structure statistics, etc.

### 5. Machine Learning Classification Model

The guardrail model 500 can also include a machine learning classification model 520. The machine learning classification model 520 can be a machine learning model that is trained to classify whether or not transcription text that is generated from an image is accurate. The machine learning classification model 520 can evaluate the combination vector that encapsulates visual, spatial, and textual characteristics of the original image and its transcription.

The guardrail model 500 can evaluate the output of the fully connected layers using the machine learning classification model 520 (e.g., a final classifier head). The machine learning classification model 520 can determine a classification for the quality of the transcription for the image of structured text. The machine learning classification model 520 can determine a probability of a certain classification for the quality of the transcription for the image of structured text. For example, the probability can be a value between 0 and 1 and the classification can be accurate or not accurate.

The machine learning classification model 520 can be a binary machine learning classification model that can identify input vectors as being associated with two distinct categories (e.g., accurate or not accurate). The machine learning classification model can be a linear machine learning classification model or a non-linear machine learning classification model and may utilize techniques such as logistic regression, K-nearest neighbors, random forests, etc.

As an illustrative example, a computer system can obtain an image of structured text (e.g., an image of a menu). The computer system can evaluate the image using a transcription model to obtain transcription text and an OCR bounding box image. The computer system can process the image, the transcription text, and the OCR bounding box image using a guardrail model to determine a set of features and generate a single combination vector based on the set of features. The computer system can generate a classification that indicates whether or not the transcription text is accurate using the combination vector. Responsive to the transcription text being classified as accurate, the computer system can display the transcription text within an application. The application can be, for example, a delivery application.

C. Multimodal Transcription Pipeline with Guardrail

In some embodiments, the guardrail model can evaluate inputs that are provided by two or more transcription models, referred to as multi-modal. The guardrail model can determine which, if any, of the text transcription are most accurate above an accuracy threshold.

FIG. 6 shows a flow diagram illustrating a second image transcription and evaluation method according to embodiments. FIG. 6 illustrates an automatic transcription pipeline with multimodal generative artificial intelligence models and a guardrail model. The method illustrated in FIG. 6 can be performed by a computer system such as a central server computer.

At step 602, the computer system can obtain an image as described herein. For example, the computer system may receive an image of a menu, receipt, or other document with structured text from a service provider computer system or an image database.

At step 604, the computer system can determine raw text from the image using an OCR process and can determine first transcription text from the raw text using a large language model, as described herein. For example, the computer system can apply the OCR process to the image to extract raw text and spatial layout information. The computer system can then process the raw text with a first transcription model, such as a large language model, which receives the raw text along with a structured prompt. The large language model can parse and organize the raw text into a structured format, such as a transcription that is formatted as tabular data.

At step 606, after determining the first transcription text for the image, the computer system can determine second transcription text. The computer system can determine the second transcription text using a machine learning model. The second transcription text can be generated by a different machine learning model than the first transcription text. For example, the computer system can determine the second transcription text using a multimodal large language model (MM-LLM) based on the image. For example, the computer system may input the image into the multimodal large language model. The multimodal large language model can be capable of processing both visual and textual information simultaneously. The multimodal large language model, which may be trained on paired image-text datasets, can evaluate the visual layout, included text, and contextual cues in the image to produce a second transcription text. This multimodal approach may offer advantages in context understanding, spatial reasoning, or robustness to OCR errors, but may also have different sensitivities to image quality or layout compared to the OCR and LLM pipeline.

A multimodal large language model can be designed to process and integrate diverse data types, or modalities, including text, images, audio, and video. Unlike traditional large language models, which operate solely on textual input, multimodal large language models can be trained on paired datasets (e.g., such as image-text pairs or video-caption pairs) enabling the multimodal large language models to understand, generate, and relate information across different types of content. Multimodal large language models can utilize transformer-based neural networks with specialized input encoders for each modality and cross-modal attention mechanisms that allow the multimodal large language model to learn joint representations and contextual relationships between modalities. As a result, multimodal large language models can perform complex tasks such as image captioning, visual question answering, image-based information extraction, and cross-modal retrieval. One such example of a multimodal language model is pathways language model embodied (PaLM-E).

Further details related to multimodal large language models can be found in “Li, S., et al. A systematic review of multi-modal large language models on domain-specific applications. Artificial Intelligence Review 58, 383 (2025). doi.org/10.1007/s10462-025-11398-1,” and “Driess, D, et al. PaLM-E: An Embodied Multimodal Language Model. arXiv: 2303.03378 [cs.LG],” which are incorporated herein by reference for all purposes.

In some embodiments, the computer system can determine any number of transcription texts based on the image using different processing techniques.

At step 608, the computer system can provide the first transcription text and the second transcription text to the guardrail model. The computer system can utilize the guardrail model to determine an accuracy score for each transcription text. The computer system can determine a first accuracy score for the first transcription text. The computer system can determine a second accuracy score for the second transcription text.

The computer system can determine whether or not one or more accuracy scores of the first accuracy score and the second accuracy score exceed an accuracy threshold. If one or more accuracy scores exceed the accuracy threshold, the computer system can proceed to step 612. If no accuracy scores exceed the accuracy threshold, the computer system can proceed to step 610.

At step 610, if no accuracy scores exceed the accuracy threshold, then the computer system can add the image and associated transcription text(s) (e.g., the first transcription text and the second transcription text) to a review queue for a reviewer to evaluate. The reviewer can evaluate the transcription text(s), select a transcription text to use, and/or create a new transcription text based on the image.

At step 612, if one or more accuracy scores exceed the accuracy threshold, the computer system can determine which transcription text to utilize. The computer system can select the transcription text that has a highest accuracy score.

At step 614, after obtaining a transcription text (e.g., a most accurate transcription text or a human reviewed and/or created transcription text) the computer system can include the transcription text into a listing, profile, or other data structure related to the service provider associated with the image.

In some embodiments, a computer system can obtain an image, determining one or more transcription texts from the image using one or more machine learning models, and determine one or more accuracy scores for the one or more transcription texts using a guardrail machine learning model. If one or more accuracy scores exceeds an accuracy threshold, the computer system can flag the highest accuracy score of the one or more accuracy scores for use in a delivery platform.

As an illustrative example, the computer system can generate a first transcription text using a first transcription model based on the image and a second transcription text using a second transcription model based on the image. The computer system can determine a first set of features based on the image and the first transcription text. The computer system can determine a second set of features based on the image and the second transcription text. The computer system can then generate a first feature vector from the first set of features and a second feature vector from the second set of features. The computer system can then determine a first accuracy classification for the first transcription text using the first feature vector and a second accuracy classification for the second transcription text using the second feature vector. The computer system can then evaluate the first accuracy classification and the second accuracy classification to determine a selected transcription text of the first transcription text and the second transcription text.

### IV. EXEMPLARY COMPONENTS AND THEIR PERFORMANCE

Embodiments provide for a model structure that can include a 3-component neural network design, utilizing pre-trained image models such as VGG16/ResNet/ViT/DiT to predict whether a transcription is accurate enough. Further, a LGBM model was also trained during experiments with tabular features for a comparison. The guardrail neural network can include any of the aforementioned models.

Table 3, below, shows the comparison among different model architectures based on two main metrics during an experiment: average transcription accuracy across all test images, and percentage of photos that met accuracy requirements. In some cases, a LGBM model outperformed other models on both metrics while maintaining the fastest run time. Neural networks with ResNet followed closely behind, while neural networks with ViT performed the worst among the list. One of the key reasons is that there is limited labeled data, making it difficult to fully take advantage of more complex model designs.

TABLE 3
Example experimental model performance

| | | Model Performance | | | | | |
|---|---|---|---|---|---|---|---|
| | | Maintaining the same performance | | | | | |
| | | as 9% (70% within 2% of IR) | | | | | |
| | Pre- | | % Mx +− 2% | | Best performance to | | |
| | trained | | of true IR | | achieve 15% goal | | |
| Model | image | % | (classifier | PG | % | % Mx +− 2% | PG |
| Type | model | automation | precision) | Precision | automation | of true IR | Precision |
| Baseline 1 - Vx | | NA | 0.77 | 0.98 | NA | | |
| transcribe top 50 | | | | | | | |
| Baseline 2 - OCR | | 0.09 | 0.7 | 0.96 | | | |
| 9% automation | | | | | | | |
| Menu | ResNet | 0.18 | 0.70 | 0.97 | 0.15 | 0.76 | 0.98 |
| photo | VGG | 0.16 | 0.70 | 0.98 | 0.15 | 0.73 | 0.98 |
| only | ViT | 0.05 | 0.7 | 1 | 0.15 | 0.66 | 0.96 |
| | DiT | 0.09 | 0.70 | 0.97 | 0.15 | 0.65 | 0.95 |
| Menu | ResNet | NA | 0.70 | NA | 0.15 | 0.58 | 0.96 |
| photo + | VGG | 0.11 | 0.70 | 0.96 | 0.15 | 0.68 | 0.95 |
| OCR | | | | | | | |
| Block | | | | | | | |
| photo + | | | | | | | |
| tabular | | | | | | | |
| features | | | | | | | |
| Menu | ResNet | 0.03 | 0.70 | 0.95 | 0.15 | 0.65 | 0.96 |
| photo + | VGG | 0.12 | 0.70 | 0.95 | 0.15 | 0.65 | 0.95 |
| tabular | | | | | | | |
| features | | | | | | | |
| OCR | ResNet | NA | 0.70 | NA | 0.15 | 0.65 | 0.96 |
| Block | VGG | NA | 0.70 | NA | 0.15 | 0.63 | 0.95 |
| photo + | | | | | | | |
| tabular | | | | | | | |
| features | | | | | | | |
| Tabular | LGBM | 0.24 | 0.70 | 0.98 | 0.15 | 0.74 | 0.99 |
| features | | | | | | | |
| only | | | | | | | |

### V. METHOD FOR GENERATION AND DEPLOYMENT

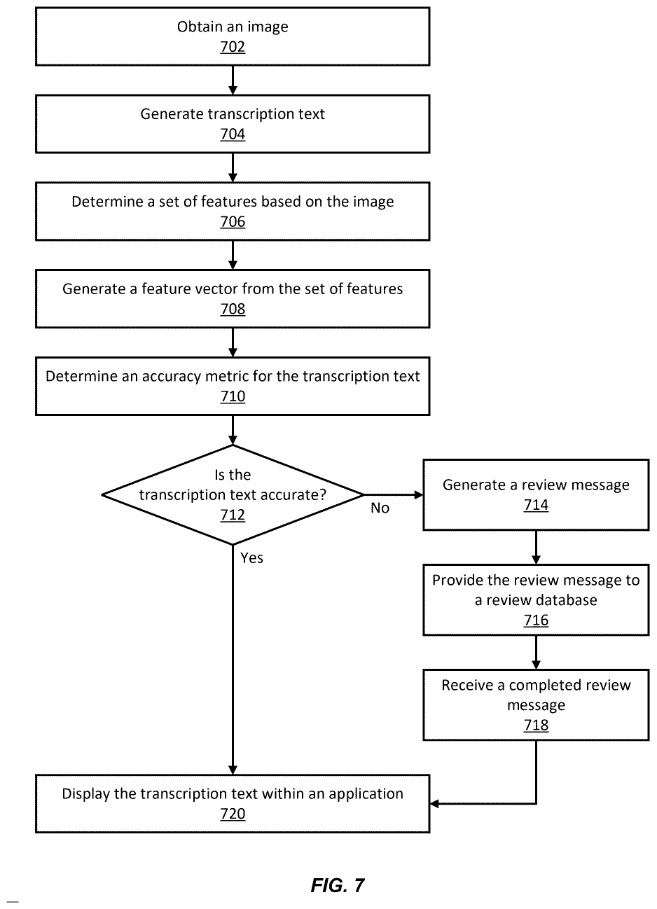

FIG. 7 shows a flow diagram illustrating a transcription generation and deployment method according to embodiments. FIG. 7 illustrates a method of generating a transcription and deploying the transcription to an application. The method illustrated in FIG. 7 can be performed by a computer system such as a central server computer.

At step 702, the computer system can obtain an image. For example, the computer system can obtain the image from a service provider computer associated with a service provider. The image can be an image of structured text, such as an image of a menu of items offered by the service provider to end users.

At step 704, the computer system can generate transcription text. The computer system can generate transcription text based on the image. The computer system can generate the transcription text using a transcription model.

In some embodiments, the computer system can generate the transcription text using a transcription model that includes an optical character recognition module and a language model (e.g., a large language model). The computer system can use the transcription model to generate raw text from the image using an optical character recognition process. The computer system can then generate a prompt comprising the raw text using a prompt template. The computer system can generate the transcription text based on the prompt using a language model.

In other embodiments, the computer system can generate the transcription text using a transcription model that includes a multimodal language model. The computer system can generate the transcription text using the multimodal language model based on the image. For example, the computer system can input the image, as well as a text prompt or other data, into the multimodal language model to generate the transcription text.

At step 706, after generating the transcription text, the computer system can determine a set of features based on the image. The computer system can determine the set of features in a guardrail model. The computer system can determine any suitable number of features for the set of features. For example, a first feature subset of the set of features can include and/or be extracted from the image. The first feature subset can represent the image itself (e.g., pixel data) or can represent data derived from the image (e.g., largest contrast difference, etc.). A second feature subset of the set of features can include and/or be extracted from the transcription text. A third feature subset of the set of features can include and/or be extracted from an optical character recognition bounding box image.

At step 708, the computer system can generate a feature vector from the set of features. The computer system can combine each feature of the set of features into a single combination vector. The computer system can combining features of the set of features using a plurality of connecting layers and a fully connected layer in a guardrail model. It is understood that the computer system can combine the features of the set of features in other manners, such as concatenating all of the features together and/or performing other mathematical manipulations on the features.

At step 710, after generating the combination vector, which can represent the image and the transcription of the structured text in the image, the computer system can determine an accuracy classification for the transcription text using the combination vector. The computer system can determine the accuracy classification using a machine learning model such as a machine learning classification model. For example, the computer system can input the combination vector into the classification machine learning model to obtain an output accuracy classification. The accuracy classification can be a value or a category.

At step 712, the computer system can evaluate the accuracy classification to determine whether or not the transcription text is accurate. For example, the computer system can compare the accuracy classification to an accuracy threshold. If the transcription text is accurate, then the computer system can proceed to step 720. If the transcription text is not accurate, then the computer system can proceed to step 714.

At step 714, if the transcription text is not accurate, then the computer system can generate a review message. The review message can include the transcription text and the image. In some embodiments, the review message can include other data related to the transcription process such as the combination vector, the sets of features, the OCR bounding box image, etc.

At step 716, after generating the review message, the computer system can provide the review message to a review database. The review database can store the review message.

At any suitable point in time thereafter, a reviewer device can obtain the review message and display the review message to a user (e.g., reviewer) of the reviewer device. The reviewer device can receive user input that includes an accurate transcription text. For example, the reviewer can transcribe the image. The accurate transcription text can be created based on user input. The reviewer device can generate a completed review message comprising the accurate transcription text. The reviewer device can provide the completed review message to the computer system. In some embodiments, the review device can provide the completed review message to the review database.

At step 718, the computer system can receive the completed review message from the reviewer device. The computer system can replace the transcription text with the accurate transcription text.

At step 720, the computer system can display the transcription text within the application. For example, the computer system can update the corresponding digital listing, user interface, or profile page associated with the service provider to include the newly verified or corrected transcription text. This may involve presenting the menu items, categories, and prices in a structured, visually organized format accessible to end users of the application, such as end users browsing a restaurant's menu on a delivery platform. The display may also enable search, filtering, or sorting of menu items.

### VI. ITEM FULFILLMENT

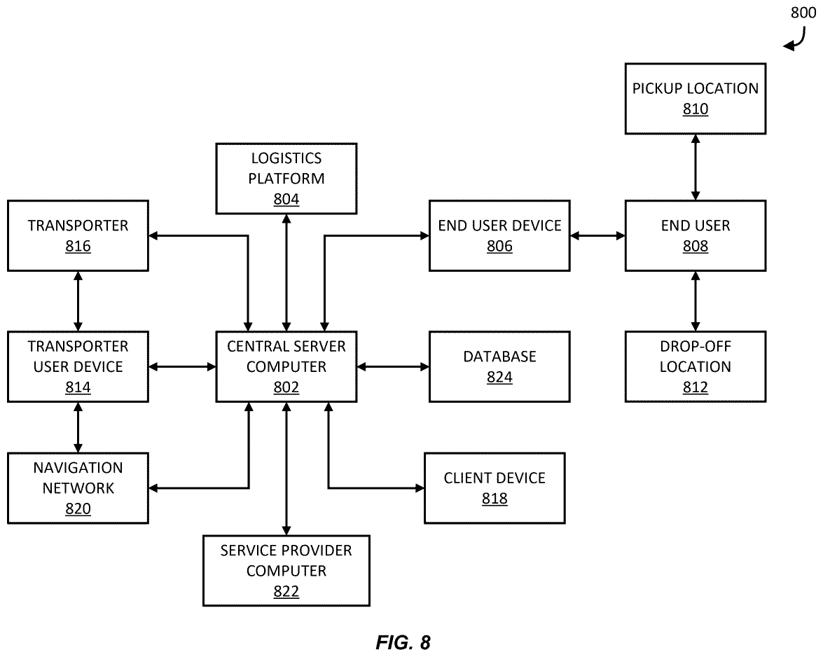

FIG. 8 shows a system 800 according to embodiments of the disclosure. The system of FIG. 8 includes a central server computer 802, a logistics platform 804, an end user device 806, an end user 808, a pickup location 810, a drop-off location 812, a transporter user device 814, a transporter 816, a client device 818, a navigation network 820, a service provider computer 822, and a database 824.

The central server computer 802 can be in operative communication with the logistics platform 804, the end user device 806, the transporter user device 814, the client device 818, the navigation network 820, the service provider computer 822, and the database 824. The transporter user device 814 can be in operative communication with the navigation network 820.

For simplicity of illustration, a certain number of components are shown in FIG. 8. It is understood, however, that embodiments of the invention may include more than one of each component. In addition, some embodiments of the invention may include fewer than or greater than all of the components shown in FIG. 8. For example, although FIG. 8 shows one transporter 816, there can be two, three, or more transporters, transporter user devices, etc.

Messages between the devices and the computers in the system 800 in FIG. 8 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 802 can include a server computer that can facilitate in the fulfillment of fulfillment requests received from the end user device 806. For example, the central server computer 802 can identify the transporter 816 (from among many candidate transporters) operating the transporter user device 814 as being suitable for satisfying the fulfillment request. The central server computer 802 can identify the transporter user device 814 that can satisfy the fulfillment request based on any suitable criteria (e.g., transporter location, service provider location, end user destination, end user location, transporter mode of transportation, etc.).

The central server computer 802 can receive data relating to a delivery order of items from the service provider computer 822 to the end user 808 at the drop-off location 812. The central server computer 802 can determine a route for delivery of the delivery order. The central server computer 802 can present the routes to a plurality of transporter user devices and/or transporters. The central server computer 802 can receive acceptances from the transporter 816 that will deliver the items from the pickup location 810 to the drop-off location 812.

The central server computer 802 can receive images from the service provider computer 822. The central server computer 802 can store the images into an image database (not shown). The central server computer 802 can determine transcription text from the images as described herein. The central server computer 802 can update menus and items associated with the service provider computer 822 as depicted on an application or website accessible by end users.

The logistics platform 804 can include a location determination system, which can determine the locations of various user devices such as transporter user devices (e.g., the transporter user device 814) and end user devices (e.g., the end user device 806). The logistics platform 804 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 804 can be part of the central server computer 802 or can be a system that is separate from the central server computer 802.

The end user device 806 can include a device operated by the end user 808. The end user devices 806 can generate and provide fulfillment request messages to the central server computer 802. The fulfillment request message can indicate that the request (e.g., a request for a service) can be fulfilled by the service provider computer 822. For example, the fulfillment request message can be generated based on a cart selected at checkout during a transaction using a central server computer application installed on the end user device 806. The fulfillment request message can include one or more items from the selected cart.

The end user device 806 can provide a fulfillment request message to the central server computer 802 that indicates that the end user device 806 is requesting that the transporter 816 pickup an item from the pickup location 810 (e.g., end user's 808 location) and deliver the item to the drop-off location 812 (e.g., the service provider computer's 822 location).

The pickup location 810 can be a location in which items are stored. In the context of an outbound delivery from an end user at an end user location, examples of the pickup location 810 may be a house or an apartment, a mailbox, a service provider location (e.g., a retail store, a grocery store, a dry cleaning store), a pickup hub, etc. Items can first be obtained from a pickup location 810 and then be transported to the drop-off location 812. Examples of the drop-off location 812 can be similar to the pickup location 810, such as a house or apartment, a mailbox, a retail store, a grocery store, a dry cleaning store, a pickup hub, etc. In one example, the pickup location 810 can be a pizza parlor from which the end user 808 orders a pizza. The drop-off location 812 can be an apartment in which the end user 808 resides.

The transporter user device 814 can include a device operated by the transporter 816. The transporter user device 814 can include a smartphone, a wearable device, a personal assistant device, etc. The transporter 816 can accept an end user's fulfillment request via an acceptance message. For example, the transporter user device 814 can generate and transmit a request to fulfil a particular end user's fulfillment request to the central server computer 802. The central server computer 802 can notify the transporter user device 814 of the fulfillment request. The transporter user device 814 can respond to the central server computer 802 with a request to perform the delivery to the end user as indicated by the fulfillment request.

In some embodiments, the transporter 816 can be an operator of a vehicle. In other embodiments, the transporter 816 can be a vehicle that can be operated by an operator or can be autonomous. The vehicle can include a car, a truck, a van, a motorcycle, a bicycle, a drone, or other vehicle.

The client device 818 can request information from the central server computer 802. The client device 818 can be operated by a user that requests information from the central server computer 802 related to a journey. In some embodiments, the client device 818 can be the transporter user device 814. In other embodiments, the client device 818 can be the end user device 806.

The navigation network 820 can provide navigational directions to the transporter user device 814. For example, the transporter user device 814 can obtain a location from the central server computer 802. The location can be a service provider parking location, a service provider location, an end user parking location, an end user location, etc. The navigation network 820 can provide navigational data to the location. For example, the navigation network 820 can be a global positioning system that provides location data to the transporter user device 814.

The service provider computer 822 include computers operated by a service provider. For example, the service provider computer 822 can be a food provider computer that is operated by a food provider. The service provider computer 822 can offer to provide services to the end user 808 of the end user device 806. In embodiments of the invention, the service provider computer 822 can receive requests to prepare one or more items for delivery from the central server computer 802. The service provider computer 822 can initiate the preparation of the one or more items that are to be delivered to the end user 808 of the end user device 806 by the transporter 816 of the transporter user device 814.

The database 824 can include any suitable database. The database may be a conventional, fault tolerant, relational, scalable, secure database such as those commercially available from Oracle™ or Sybase™. The database 824 can store supplemental information (e.g., an image, a text message, etc.), the location datum (e.g., a location that includes a latitude and longitude, etc.), and the time datum (e.g., a specific time).

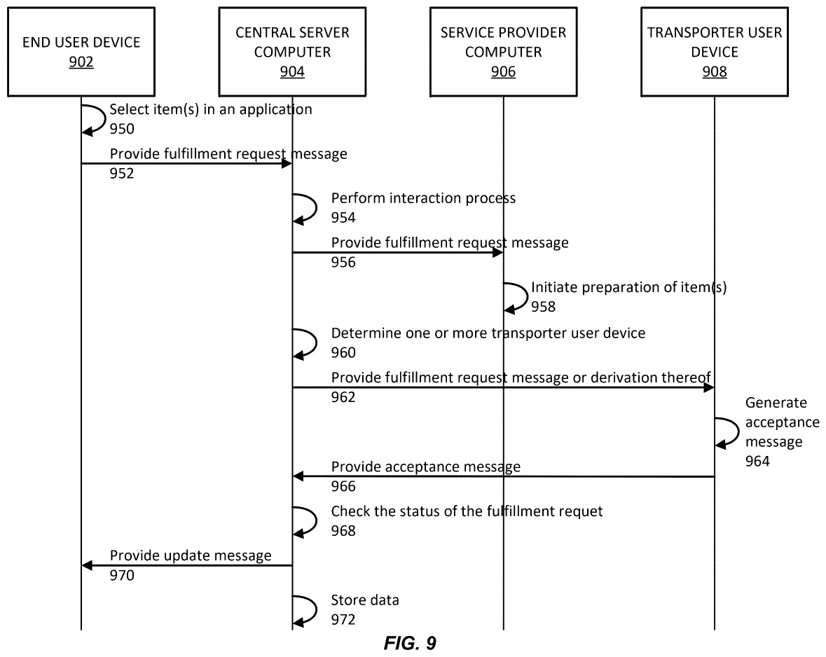

FIG. 9 shows a flow diagram illustrating a preparation and delivery method of an item according to embodiments. The method illustrated in FIG. 9 will be described in the context of the central server computer 904 receiving a fulfillment request message from an end user device 902 to fulfill preparation and delivery of one or more items from a cart to an end user of the end user device 902. The central server computer 904 can communicate with a service provider computer 904 and a transporter user device 908 to fulfill the fulfillment request.

At step 950, the end user device 902 can decide to check out with a cart in a central server computer delivery application installed on the end user device 902. The cart can include one or more items that are provided from a service provider of the service provider computer 904.

At step 952, after checking out with the cart, the end user device 902 can provide a fulfillment request message including the one or more items from the cart to the central server computer 904. The fulfillment request message can also include a service provider computer identifier that identifies the service provider computer 904.

At step 954, after receiving the fulfillment request message, the central server computer 904 can perform an interaction process (e.g., a transaction process) with the end user device 902. For example, the central server computer 904 can communicate with a payment network to process the transaction for the one or more items. The central server computer 904 can receive an indication of whether or not the transaction is authorized. If the transaction is authorized, then the central server computer 904 can proceed with step 908.

At step 956, the central server computer 904 can provide the fulfillment request message, or a derivation thereof, to the service provider computer 904. The central server computer 904 can determine which service provider computer of a plurality of service provider computers to communicate with based on the service provider indicated in the fulfillment request message. For example, the fulfillment request message can indicate that the one or more items are provided by the service provider of the service provider computer 904. The central server computer 904 can identify the service provider computer 904 using the service provider computer identifier in the fulfillment request message.

At step 958, after receiving the fulfillment request message, the service provider computer 904 can initiate preparation of the one or more items. For example, the service provider computer 904 can alert service provider personnel (e.g., those preparing the items) at the service provider location. The service providers can prepare the one or more items for pick up by a transporter.

At step 960, after providing the fulfillment request message to the service provider computer 904, the central server computer 904 can determine one or more transporters operating one or more user devices that are capable of fulfilling the fulfillment request message. The central server computer 904 can determine the one or more transporters from the transporter user devices. The central server computer 904 can determine the one or more transporter user devices based on whether or not the transporter user device is online, whether or not the transporter user device 908 is already fulfilling a different fulfillment request message, a location of the transporter user device 908, etc.

At step 962, after determining the one or more transporter user devices, the central server computer 904 can provide the fulfillment request message, or a derivation thereof, to the one or more transporter user devices including the transporter user device 908.

At step 964, after receiving the fulfillment request message, the transporter of the transporter user device 908 can determine whether or not they want to perform the fulfillment. The transporter can decide that they want to perform the delivery of the one or more items from the service provider location to the end user location. The transporter user device 908 can generate an acceptance message that indicates that the fulfillment request is accepted.

At step 966, after generating the acceptance message, the transporter user device 908 can provide the acceptance message to the central server computer 904.

After providing the acceptance message to the central server computer 904, the transporter user device 908 can communicate with a navigation network and the transporter can proceed to the service provider location to obtain the one or more items. The transporter user device 908 can then receive input from the transporter that indicates that the transporter obtained the one or more items (e.g., the transporter selects that they picked up the items). The transporter user device 908 can then communicate with the navigation network and the transporter can then proceed to the end user location to provide the one or more items to the end user. In some embodiments, the transporter user device 908 can provide update messages to the central server computer 904 that include a transporter user device 908 location and/or event data (e.g., items picked up, items delivered, etc.).

In some embodiments, after receiving the acceptance message, the central server computer 904 can notify the other transporter user devices that received the fulfillment request message that the fulfillment request is no longer available.

At step 968, at any point after receiving the acceptance message, the central server computer 904 can check the status of the fulfillment request. For example, the central server computer 904 can determine the location of the transporter user device 908 and can determine an estimated amount of time for the transporter user device 908 to arrive at the end user location.

At step 970, the central server computer 904 can provide an update message to the end user device 902 that includes data related to the fulfillment of the fulfillment request message. The data can include an estimated amount of time, the transporter user device location, event data (e.g., items picked up from the service provider), and/or other data related to the fulfillment of the fulfillment request message.

At step 972, the central server computer 904 can store any data received, sent, and/or processed during the fulfillment of the fulfillment request message into a database. For example, the central server computer 904 can store a user's cart selection as user features into a user feature database.

In some embodiments, the end user may search for a particular item using a search bar. In such case, the central server computer 904 can use image filtering to surface contextualized images on the search feed that includes the item related to what an end user has searched. By providing the image related to what the user has searched, the user does not have to search through an entire menu to look for an item. For example, in FIG. 9, when a user searches for a “burger”, images related to the word “burger” for merchants are displayed in a screen.

In some embodiments, the plurality of images can be images of the plurality of service providers and the inquiry request can be with respect to determining a service provider of the plurality of service providers. For example, an image can be an image of an item that can be provided by the service provider to the end user via the transporter.

For example, the central server computer can determine which service providers are displayed on the homepage. The homepage of the delivery application can have a plurality of “slots” that each can display a service provider. For each slot on the homepage, the central server computer can use a scoring algorithm to determine a service provider of the plurality of service providers to display in the delivery application.

### VII. ADVANTAGES

Embodiments provide for a number of advantages. For example, embodiments provide for a flexible technical solution to productionize large language models when the large language models fail to reach the required accuracy goal on average, while there is limited time and computational resources for further large language model fine-tuning. The guardrail model approach increases automation coverage without sacrificing data quality by ensuring that high-confidence cases are handled automatically, while more challenging cases are directed to human transcribers. This selective automation significantly reduces time costs and manual workload, enabling scalable and rapid image text transcription.

### VIII. EXEMPLARY DEVICES

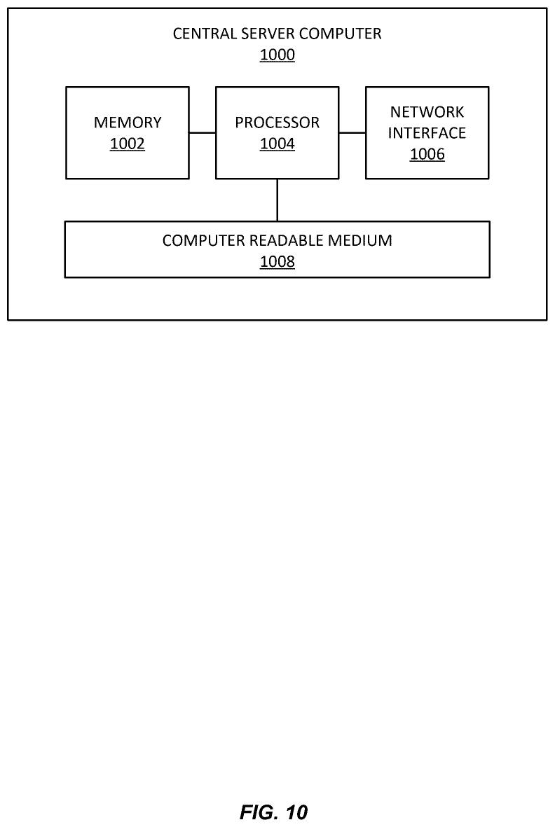

FIG. 10 shows a block diagram of a central server computer 1000 according to embodiments. The central server computer 1000 may comprise a processor 1004. The processor 1004 may be coupled to a memory 1002, a network interface 1006, and a computer readable medium 1008. The computer readable medium 1008 can comprise a one or more modules.

The memory 1002 can be used to store data and code. For example, the memory 1002 can store images, text data, machine learning models, machine learning model data, etc. The memory 1002 may be coupled to the processor 1004 internally or externally (e.g., cloud based data storage), and may comprise any combination of volatile and/or non-volatile memory, such as RAM, DRAM, ROM, flash, or any other suitable memory device.

The computer readable medium 1008 may comprise code, executable by the processor 1004, for performing methods described herein.

The network interface 1006 may include an interface that can allow the central server computer 1000 to communicate with external computers. The network interface 1006 may enable the central server computer 1000 to communicate data to and from another device (e.g., the logistics platform, the end user device 806, the transporter user device 814, the transporter 816, the client device 818, the navigation network 820, the service provider computer 822, etc.). Some examples of the network interface 1006 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 1006 may include Wi-Fi™. Data transferred via the network interface 1006 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 1006 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

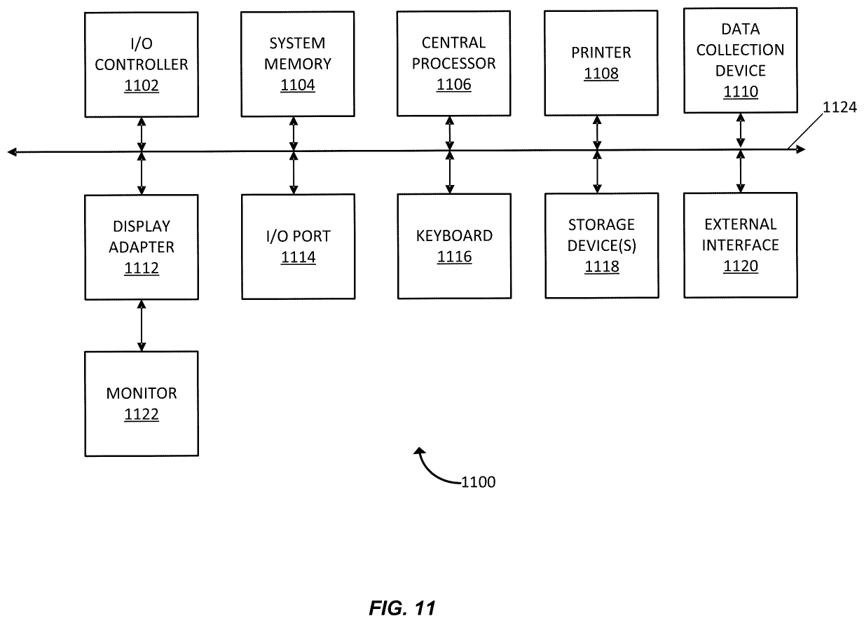

Any of the computer systems mentioned herein may utilize any suitable number of subsystems. Examples of such subsystems are shown in FIG. 11 in computer system 1100. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 11 are interconnected via a system bus 1124. Additional subsystems such as a printer 1108, keyboard 1116, storage device(s) 1118, monitor 1122 (e.g., a display screen, such as an LED), which is coupled to display adapter 1112, and others are shown. Peripherals and input/output (I/O) devices, which couple to I/O controller 1102, can be connected to the computer system by any number of means known in the art such as input/output (I/O) port 1114 (e.g., USB, FireWire®). For example, I/O port 1114 or external interface 1120 (e.g., Ethernet, Wi-Fi, etc.) can be used to connect computer system 1100 to a wide area network such as the Internet, a mouse input device, or a scanner. The interconnection via system bus 1124 allows the central processor 1106 to communicate with each subsystem and to control the execution of a plurality of instructions from system memory 1104 or the storage device(s) 1118 (e.g., a fixed disk, such as a hard drive, or optical disk), as well as the exchange of information between subsystems. The system memory 1104 and/or the storage device(s) 1118 may embody a computer readable medium. Another subsystem is a data collection device 1110, such as a camera, microphone, accelerometer, and the like. Any of the data mentioned herein can be output from one component to another component and can be output to the user.

A computer system can include a plurality of the same components or subsystems, for example, connected together by external interface 1120, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device (e.g., as firmware) or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

Although the steps in the flowcharts and process flows described above are illustrated or described in a specific order, it is understood that embodiments of the invention may include methods that have the steps in different orders. In addition, steps may be omitted or added and may still be within embodiments of the invention.

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional. As such, this statement is intended to serve as antecedent basis for use of such exclusive terminology as “solely”, “only”, and the like in connection with the recitation of claim elements, or the use of a “negative” limitation.

All patents, patent applications, publications, and descriptions mentioned herein are incorporated by reference in their entirety for all purposes. None is admitted as prior art. Where a conflict exists between the instant application and a reference provided herein, the instant application shall dominate.

What is claimed is:

1. A method comprising:
obtaining an image of structured text;
generating transcription text based on the image using a transcription model;
determining a set of features based on the image, wherein a first feature subset of the set of features is extracted from the image, and wherein a second feature subset of the set of features is extracted from the transcription text;
generating, by a first image model, an image representation vector using the first feature subset, wherein the first image model includes a first image convolutional network or a first transformer model;
generating, by tabular layer model, a transcription representation vector using the second feature subset;
generating a combination vector by combining the image representation vector and the transcription representation vector;
determining, by a machine learning classification model, an accuracy classification for the transcription text using the combination vector; and
responsive to the accuracy classification indicating that the transcription text is accurate, displaying the transcription text within an application.

2. The method of claim 1, wherein obtaining the image comprises:
obtaining the image from a service provider computer associated with a service provider, wherein the image is an image of a menu of items offered by the service provider to end users.

3. The method of claim 1, wherein generating the transcription text using the transcription model comprises:
generating raw text from the image using an optical character recognition process;
generating a prompt comprising the raw text using a prompt template; and
generating the transcription text based on the prompt using a language model.

4. The method of claim 1, wherein the transcription model is a multimodal language model that is trained to generate text outputs based on multimodal inputs.

5. The method of claim 1, wherein a third feature of the set of features is an optical character recognition bounding box image, and wherein the method further comprises:
generating an optical character recognition bounding box image representation vector based on the third feature using a second image convolutional network or a second transformer model.

6. The method of claim 5, wherein generating the optical character recognition bounding box image representation vector based on the third feature using the second image convolutional network or the second transformer model comprises:
generating a vector using the second image convolutional network or the second transformer model that represents the second feature subset; and
projecting the vector into the optical character recognition bounding box image representation vector, wherein the optical character recognition bounding box image representation vector is of a fixed size.

7. The method of claim 5, further comprising:
generating the optical character recognition bounding box image based on the image using an optical character recognition process.

8. The method of claim 7, wherein generating the optical character recognition bounding box image comprises:
determining segments of text in the image;
for each segment of text in the image, determining pixel coordinates of a quadrilateral that encompasses the segment; and
generating the optical character recognition bounding box image using the pixel coordinates of each quadrilateral.

9. The method of claim 1, wherein the transcription text is first transcription text, the set of features is a first set of features, the combination vector is a first combination vector, wherein the transcription model is a first transcription model, and the accuracy classification is a first accuracy classification, wherein the method further comprises:
generating second transcription text based on the image using a second transcription model that is different than the first transcription model;
determining a second set of features based on the image;
generating a second combination vector from the second set of features;
determining a second accuracy classification for the second transcription text using the second combination vector; and
evaluating the first accuracy classification and the second accuracy classification to determine a selected transcription text of the first transcription text and the second transcription text.

10. The method of claim 9, displaying the transcription text within the application comprises:
displaying the selected transcription text within the application.

11. The method of claim 9, wherein the first transcription model comprises an optical character recognition module and a large language model, and wherein the second transcription model comprises a multimodal language model.

12. The method of claim 1, wherein the accuracy classification is a value or a category, and wherein the machine learning classification model is trained to generate accuracy classifications based on input vectors that represent images and the image's textual contents, and wherein the method further comprises:
comparing the accuracy classification to a threshold to determine whether or not the accuracy classification indicates that the transcription text is accurate.

13. The method of claim 1, wherein generating the image representation vector based on the first feature subset using the first image convolutional network or the first transformer model comprises:
generating a vector using the first image convolutional network or the first transformer model that represents the first feature subset; and
projecting the vector into the image representation vector, wherein the image representation vector is of a fixed size.

14. The method of claim 1, wherein generating the combination vector comprises:
generating the combination vector based on each feature of the set of features using a combining layer that includes a fully connected neural network that is trained to combine inputs into a single output.

15. A computer comprising:
a processor; and
a non-transitory computer readable medium comprising code, executable by the processor for performing a method comprising:
obtaining an image of structured text;
generating transcription text based on the image;
determining a set of features based on the image, wherein a first feature subset of the set of features is the image, and wherein a second feature subset of the set of features is the transcription text;
generating a combination vector from the set of features;
determining an accuracy classification for the transcription text using the combination vector; and
responsive to the accuracy classification indicating that the transcription text is accurate, displaying the transcription text within an application.

16. The computer of claim 15, wherein the transcription text is first transcription text, the set of features is a first set of features, the combination vector is a first combination vector, and the accuracy classification is a first accuracy classification, wherein the method further comprises:
generating second transcription text based on the image;
determining a second set of features based on the image;
generating a second combination vector from the second set of features;
determining a second accuracy classification for the second transcription text using the second combination vector; and
evaluating the first accuracy classification and the second accuracy classification to determine a selected transcription text of the first transcription text and the second transcription text.

17. The computer of claim 15, wherein the transcription text is generated using a transcription model, and wherein generating the transcription text comprises:
generating raw text from the image using an optical character recognition process;
generating a prompt comprising the raw text using a prompt template; and
generating the transcription text based on the prompt using a language model.

18. The computer of claim 15, wherein the application is a delivery application, wherein the delivery application displays the transcription text to end users, wherein the transcription text is formatted as tabular data, wherein the tabular data includes columns of item name, description, and category, and wherein a third feature of the set of features is an optical character recognition bounding box image, wherein the method further comprises:
generating the optical character recognition bounding box image based on the image using an optical character recognition process.

19. A system comprising:
an image database that stores a plurality of images; and
a computer comprising:
a processor; and
a non-transitory computer readable medium comprising code, executable by the processor for performing a method comprising:
obtaining an image of structured text from the image database;
generating transcription text based on the image;
determining a set of features based on the image, wherein a first feature subset of the set of features is the image, and wherein a second feature subset of the set of features is the transcription text;
generating a combination vector from the set of features;
determining an accuracy classification for the transcription text using the combination vector; and
responsive to the accuracy classification indicating that the transcription text is accurate, displaying the transcription text within an application.

20. The system of claim 19, wherein the computer is a central server computer, wherein the system further comprises:
a review database, wherein the method further comprises:
responsive to the accuracy classification indicating that the transcription text is not accurate, generating a review message comprising the transcription text and the image;
providing the review message to the review database, wherein a reviewer device obtains the review message, generates a completed review message comprising an accurate transcription text based on user input, and provides the completed review message to the computer; and
displaying the accurate transcription text within the application.
